(19) United States
(12) Patent Application Publication
(10) Pub. No.: US 2008/0151395 A1
(43) Pub. Date: Jun. 26, 2008

(54) Aid for Reading Product Labels

(76) Inventor: Roy Ghandi-Schwatlo, Dublin, NH (US)

Correspondence Address: DANIEL S. COOLIDGE;COOLIDGE & GRAVES PLLC, 36 OLD CHANDLERS MILLS ROAD, UNITY, NH, 03743, US

(21) Appl. No.: 11/614,263

(22) Filed: Dec. 21, 2006

(51) Int. Cl. G02B 27/02

(52) U.S. Cl. 359/802

(57) ABSTRACT

A product label reading aid is described suitable for placement extending from a shelf such as may be found in the grocery store, pharmacy, or other retail outlet. The aid comprises a surface with an opening, a Fresnel lens covering the opening, means for attaching the aid to a shelf, and means for holding changeable advertising and/or informational placards, and/or coupons.

### TECHNICAL FIELD

The present invention relates to advertising media, and particularly to traffic attractors.

### BACKGROUND INFORMATION

It is well-known that the average age in the United States is increasing. In part this is due to demographics arising from the aging of the baby boom generation, and in part due to other factors such as improved health care, nutrition and exercise.

One concomitant of aging is, frequently, a decreased ability to read fine print, or presbyopia. Unfortunately, much important information, in particular nutritional information on food products, and possibly more importantly, warnings, contraindications and instructions on pharmaceutical products—both prescription and OTC—compete for space on product labels which frequently results in such information being printed in very small type.

It is of vital importance to those who must take daily medications or regulate their diet, be it due to diabetes, diet restrictions, or simply the desire to lose weight, to know what is in a particular food or pharmaceutical product.

In addition, many people are allergic to particular ingredients and must be on their guard to assure themselves that such an ingredient is not contained in a desired food, pharmaceutical or household product. These concerns grow increasingly important as we age. Indeed, we are seeing an epidemic of adult onset diabetes, particularly among the baby boom generation.

The combination of decreased ability to read small print and increased necessity to be able to read nutritional labels and contents on food packages, as well as safety concerns with pharmaceutical labels and instructions poses a problem. For many people, simple vanity discourages the use of reading glasses. Moreover, many people do not require reading glasses for other than reading the extremely small print in which nutritional information and safety warnings frequently are printed.

Unfortunately, the provision of reading aids in stores costs money, something that stores operating on very low margins are reluctant to spend.

What is needed is a way to enable the visually impaired as well as the aging population to read the fine print on product labels in a way that does not offend their vanity nor require the carrying of visual aids such as reading glasses. Moreover, it should be such as to encourage the reading of product labels as well as be inexpensive and revenue neutral if not revenue enhancing.

### BRIEF SUMMARY

In one embodiment, a product label reading aid comprises a generally horizontal planar surface and a generally vertical planar surface made of a suitable stiff material such as cardboard or plastic or sheet metal or a combination of such materials. The generally horizontal planar surface has a cutout portion over which a Fresnel lens is placed or inserted. Product packaging viewed through the Fresnel lens may be magnified thereby. The generally vertical planar surface has means for holding an advertising or informational placard and/or coupons.

In another embodiment, the generally horizontal planar surface has one or more price rail clips attached, by which the reading aid may be attached to a price rail and held thereby. In another embodiment, the vertical planar surface has one or more clips along one edge, which clips have a planar portion generally perpendicular to the generally vertical planar surface of the reading aid. Double-sided adhesive tape may be placed on the flat surface of the clips to hold the reading aid to a vertical shelf support.

In yet another embodiment, the reading aid could also be constructed of a single stiff plastic sheet formed into a right angle, where the horizontal plane is a Fresnel lens and the vertical plane is comprised of a “sleeve” to hold an advertising placard and/or coupons.

In yet still another embodiment, the product label reading aid comprises a single planar surface with a cutout portion into which a Fresnel lens is placed. Along one or more perimeter areas around the Fresnel lens, means is provided for holding one or more changeable advertising or informational placards and/or coupons.

### BRIEF DESCRIPTION OF THE DRAWINGS

These and other features and advantages of the present invention will be better understood by reading the following detailed description, taken together with the drawings wherein:

FIG. 1 is an oblique view of a bi-planar reading aid.

FIG. 2 is a front view of a vertical single plane reading aid.

Like reference numbers and designations in the various drawings indicate like elements.

### DETAILED DESCRIPTION

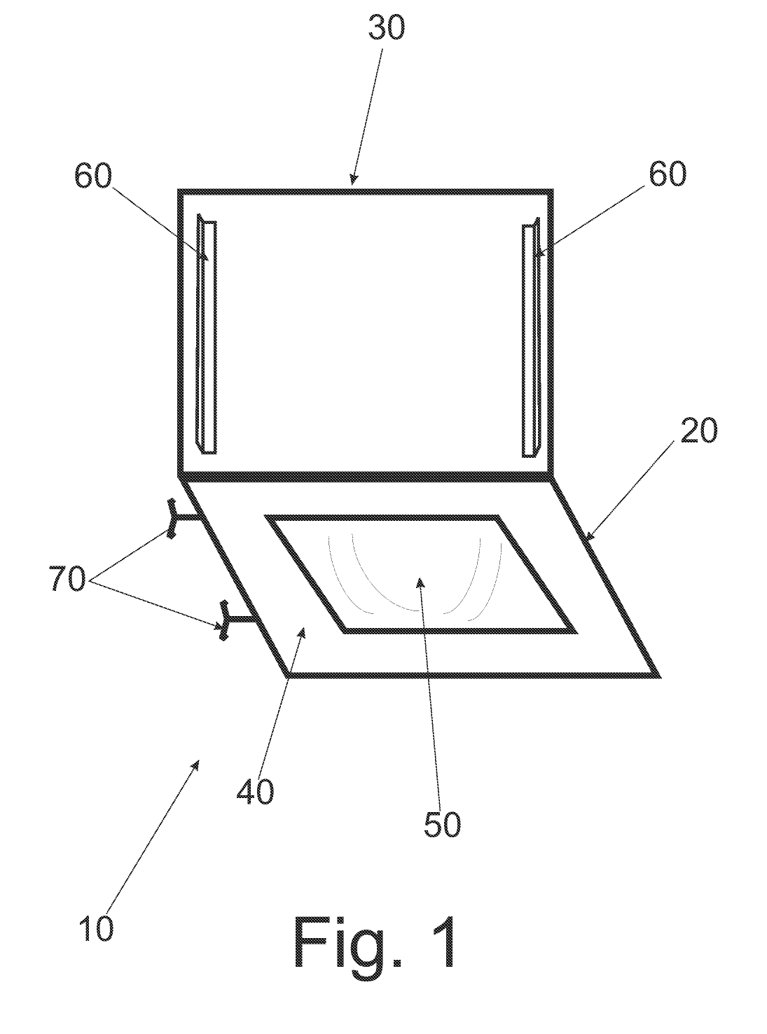

The details of one or more embodiments of the invention are set forth in the accompanying drawings and the description below. Other features and advantages of the invention will become apparent from the description, the drawings, and the claims. Referring to FIG. 1, a bi-planar reading aid 10 is shown. The aid comprises a generally horizontal surface 20 and a generally vertical surface 30. The generally horizontal surface 20 has an opening covered by a Fresnel lens 50. An object placed beneath the Fresnel lens will be magnified. A wide perimeter 40 50 may be provided around the Fresnel lens on which may be printed legends, such as information on how to read a product label.

A generally vertical surface 30 is provided with means for holding a placard and/or coupons. Such a placard can contain advertising material, public service announcements or the like. If advertising material is used, revenue from this advertising can be used to offset the cost of the reading aid 10. In the embodiment shown, the placard is held in place by two rails 60.

Alternatively, other means may be used such as tape, a plastic sleeve, clips or other means known in the art.

The entire reading aid as shown further comprises two rail clips 70 attached to the reading aid 10 along one edge. The rail clips 70 can be inserted to a standard price rail as found in most supermarkets, pharmacies, and other retail outlets. The reading aid 10 need not necessarily be attached to a price rail, although doing so has the advantage of not reducing shelf space that might otherwise be blocked by the reading aid.

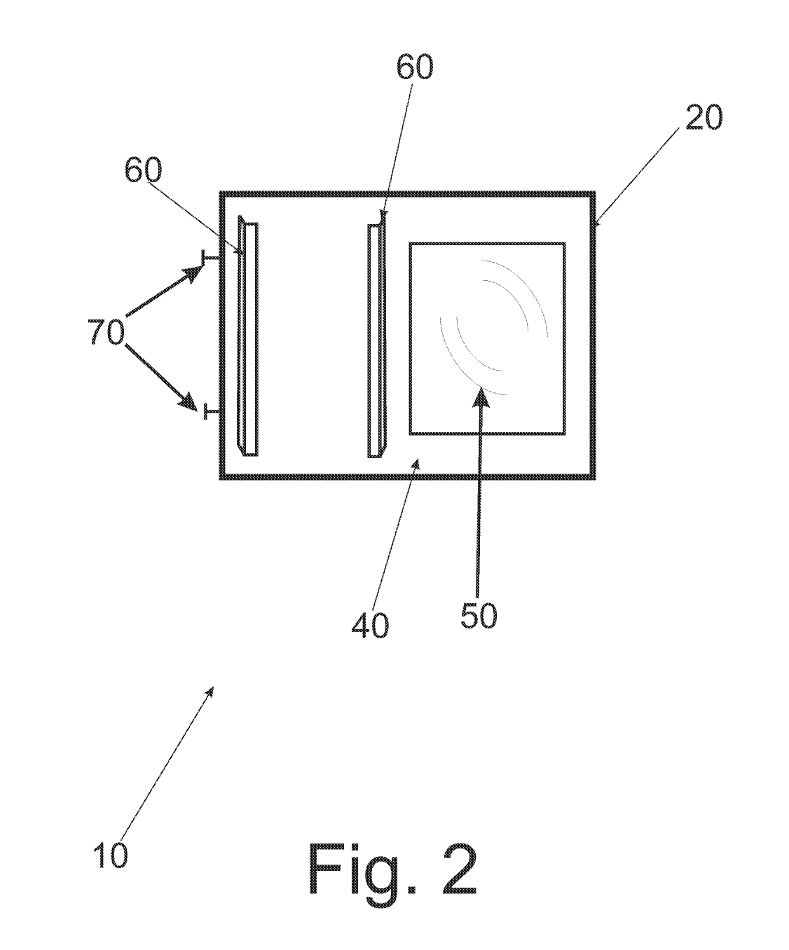

Referring to FIG. 2, a mono-planar embodiment of the reading aid 10 is shown. In this embodiment, the reading aid 10 is designed to be mounted vertically. In the embodiment is shown, two mounting clips 70 are shown intended to be held in place by double-sided sticky tape attached to a vertical shelf support. The body of the reading aid 10 comprises a planar surface 20 having a cutout over which a Fresnel lens 50 has been placed. Rails 60 for holding a placard are shown along the right side of the Fresnel lens. A wide margin 40 is provided around the Fresnel lens 50 to provide for both an advertising or informational placard and/or printed matter.

The invention has been described in terms of particular embodiments. Other embodiments are within the scope of the following claims. For example, the reading aid may include or be attached to a pad or roll of coupons offering discounts on products, and/or may further comprise a flashing LED as an attractor. The lens holder need not be rectangular—other attractive shapes may be used.

Modifications and substitutions by one of ordinary skill in the art are considered to be within the scope of the present invention, which is not to be limited except by the following claims.

The invention claimed is:

1. A product label reading aid comprising a generally horizontal planar surface made of a lightweight stiff material, said surface having a centrally cut-out portion, and further comprising a lens covering said centrally cutout portion, further comprising means for attaching said reading aid to a support.

2. The product label reading aid of claim 1, further comprising at least one perimeter area of said planar surface, said at least one perimeter having means for holding a placard.

3. The product label reading aid of claim 1 wherein the lens further comprises a Fresnel lens.

4. The product label reading aid of claim 1 wherein said horizontal planar surface comprises cardboard.

5. The product label reading aid of claim 1 wherein said horizontal planar surface comprises plastic.

6. The product label reading aid of claim 1 wherein said planar surface further comprises means for dispensing coupons.

7. The product label reading aid of claim 1, further comprising a generally vertical planar surface, said generally vertical planar surface further comprising means for holding a placard.
